(19) United States
(12) Patent Application Publication
(10) Pub. No.: US 2020/0100055 A1
(43) Pub. Date: Mar. 26, 2020

(54) OBJECT TRACKER

(71) Applicant: Honeywell International Inc., Morris Plains, NJ (US)

(72) Inventors: Hai D. Pham, Eden Prairie, MN (US); Robert C. Becker, Golden Valley, MN (US); Christian Larson, Golden Valley, MN (US); Adam P. Boutz, Golden Valley, MN (US)

(21) Appl. No.: 16/138,481

(22) Filed: Sep. 21, 2018

(51) Int. Cl. H04W 4/02; H04W 4/90; H04W 4/80; G01S 5/04; G06F 1/16

(52) U.S. Cl. CPC H04W 4/023; H04W 4/90; G06F 1/163; G01S 5/04; H04W 4/80

(57) ABSTRACT

Devices, methods, systems, and computer-readable media for tracking a location of an object are described herein. One or more embodiments include a receive element to receive wireless transmissions from a plurality of nodes including range data of an object from each of the plurality of nodes, a position calculator to convert the range data to distance measurements of the distance of each of the plurality of nodes to the object, and a transmit element to transmit the distance measurements to a command node.

### TECHNICAL FIELD

The present disclosure relates to methods, devices, systems, and computer-readable media for tracking a location of an object.

### BACKGROUND

Object trackers can be utilized in many fields. High risk workers who are in large buildings, warehouses, oil and gas refineries, first responders, firefighters, police, and members of the military can use object trackers frequently. For example, object trackers can track the location of a firefighter in a burning building. If the firefighter gets injured or down and needs assistance, the firefighter can be automatically located using an object tracker.

Tracking objects and people can be done using a global position system (GPS). However, in some environments, GPS is unavailable or unreliable. These environments can be called GPS denied environments. Tracking in a GPS denied environment can be extremely difficult. Often users of object trackers, like first responders or military personnel in war zones, are entering areas where GPS is unavailable. For example, GPS can be unavailable in some buildings.

Current object tracking devices that do not require the use of GPS can be expensive and can require a lengthy installation and calibration process prior to use. A lengthy installation and calibration process can result in a delay to searching for victims, for example. In some circumstances, a delay can lead to more severe injuries or a loss of life.

### BRIEF DESCRIPTION OF THE DRAWINGS

FIG. 1 is a diagram of an example object tracker that can be utilized according to an embodiment of the present disclosure.

FIG. 2 is a diagram of an example of a system for an object tracker that can be utilized according to an embodiment of the present disclosure.

FIG. 3 is a diagram illustrating trilateration according to an embodiment of the present disclosure.

### DETAILED DESCRIPTION

The present disclosure relates to methods, devices, systems, and computer-readable media for tracking a location of an object.

A location of an object can be tracked according to embodiments of the present disclosure. For example, in some embodiments, the object can be tracked using an object tracker. In various embodiments, the object tracker can be coupled to the object.

The object tracker can be, but is not limited to, a radio, a mobile device, or a wearable device. The wearable device can be a smart watch, smart goggle, smart safety vest, smart safety shoes, smart headphone, or smart fall protection safety harness device, for example.

The object tracker can include a receive element, a position calculator, and a transmit element. The receive element can allow the object tracker to receive wireless transmissions from a plurality of nodes. The wireless transmissions can be received from the plurality of nodes at particular intervals and/or received based on an event.

The wireless transmissions can include range data of the object from the plurality of nodes. For example, the range data can be range data between the object and each of the plurality of nodes.

A position calculator can convert the range data to a measurement of the distance of each node to the object. The range data can be converted by the position calculator using a trilateration algorithm and a processor.

In some embodiments, the transmit element of the object tracker can transmit a request to the plurality of nodes to request range data. The transmit element can also transmit the distance measurements to a command node. The wireless transmissions can be transmitted via long range (LoRa) modulated, LoRaWAN, Wi-Fi, 15.4 mesh, Bluetooth, Bluetooth mesh, or a combination thereof. For example, the wireless transmissions can be transmitted using a 2.4 GHz industrial, scientific, and medical radio band (ISM band) LoRa modulation, which is a combination of LoRa, Wi-Fi, 15.4, and Bluetooth mesh.

The command node can receive the distance measurements. The distance measurements can be conveyed by the command node to a user. The command node can be, but is not limited to, a cloud server or a mobile device, such as a smart phone, tablet, or computer with an ethernet connection.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

The figures herein follow a numbering convention in which the first digit corresponds to the drawing figure number and the remaining digits identify an element or component in the drawing. Similar elements or components between different figures may be identified by the use of similar remaining digits.

As used herein, “a” or “a number of” something can refer to one or more such things. For example, “a number of devices” can refer to one or more devices.

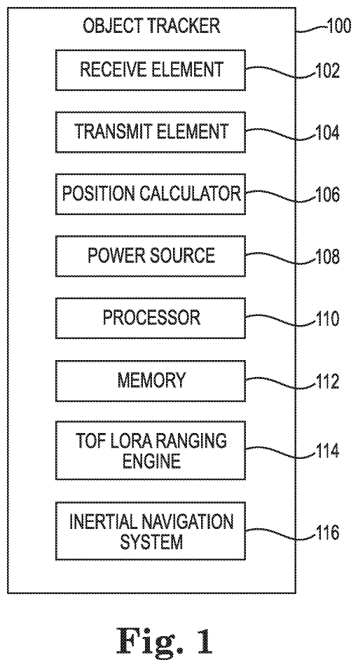

FIG. 1 is a diagram of an example object tracker that can be utilized according to an embodiment of the present disclosure. In some examples, an object tracker 100 can include a receive element 102, a transmit element 104, a position calculator 106, a power source 108, a processor 110, a memory 112, a time of flight (ToF) LoRa ranging engine 114, and an inertial navigation system 116.

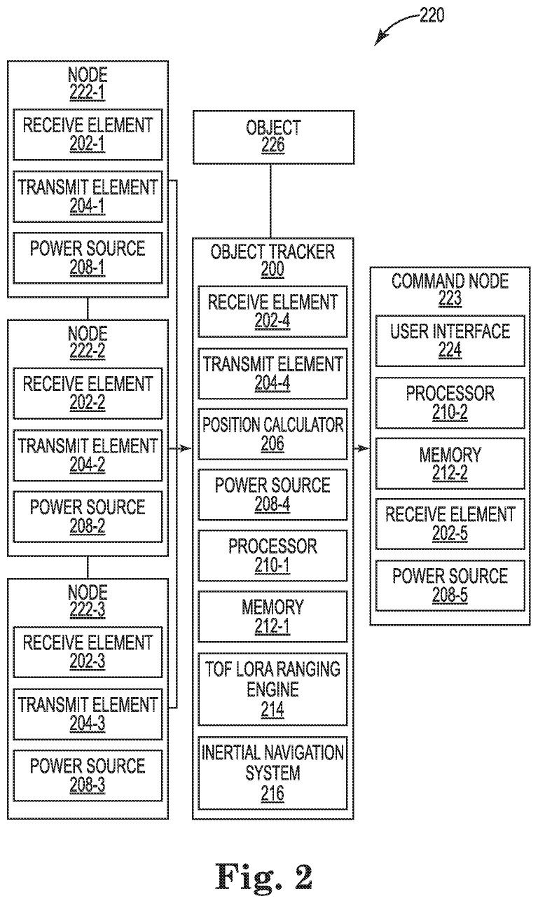

An object tracker 100 can be used to track a location of an object (e.g., object 226 in FIG. 2), which can be a person, animal, or item, for example. In some embodiments, the object tracker 100 can be coupled to the object.

The object tracker can be, but is not limited to, a radio, a mobile device, or a wearable device. The wearable device can be a smart watch, smart goggle, smart safety vest, smart safety shoes, smart headphone, or smart fall protection safety harness device, for example.

The receive element 102 of the object tracker 100 can allow the object tracker 100 to receive wireless transmissions from a plurality of nodes (plurality of nodes 222-1, 222-2, 222-3 in FIG. 2). In some examples, the receive element 102 can be an antenna. In some examples, the receive element 102 can also be a LoRa ToF device.

The wireless transmissions can be received from the plurality of nodes (e.g., plurality of nodes 222-1, 222-2, 222-3) continuously or at particular intervals. For example, the wireless transmissions can be received every minute or every hour.

In some embodiments, the wireless transmissions can be received based on an event. For example, the wireless transmissions can be received in response to the object (e.g., object 226 in FIG. 2) moving or not moving (e.g., remaining still) after a period of time. The inertial navigation system 116 can be used to detect whether or not the object is moving or not moving.

The inertial navigation system 116 can include an accelerometer. The accelerometer can detect movement of the object (e.g., object 226 in FIG. 2). In some examples, the inertial navigation system 116 can indicate a heading and a velocity of the object.

The wireless transmissions can include range data of the object (e.g., object 226 in FIG. 2) from a plurality of nodes (e.g., plurality of nodes 222-1, 222-2, 222-3 in FIG. 2). For example, the range data can be range data between the object and each of the number of nodes of the plurality of nodes that respond to the object tracker 100.

The range data can also be ToF LoRa ranging data. The ToF LoRa ranging engine 114 can be used to analyze the ToF LoRa ranging data. For example, the ToF LoRa ranging engine 114 can measure the signal strength of the responses from each of the number of nodes.

The position calculator 106 can convert the range data to a measurement of the distance of each responding node of the plurality of nodes (e.g., plurality of nodes 222-1, 222-2, 222-3 in FIG. 2) to the object (e.g., object 226 in FIG. 2). The distance measurements can be radial distances. That is, the distance measurements can be the shortest distance between the object and a responding node of the plurality of nodes. The distance measurements can be in a Cartesian coordinate system in absolute x-coordinates and y-coordinates, with units of feet, miles, yards, meters, or kilometers, for example, or a position-relative measurement. The range data can be converted by the position calculator 106 using a trilateration algorithm and the processor 110.

In various embodiments, the object tracker 100 can include a memory 112. The memory 112 can store the range data and the distance measurements. The memory 112 can also store locations of the plurality of nodes (e.g., plurality of nodes 222-1, 222-2, 222-3 in FIG. 2) to be used by the position calculator 106 in determining the location of the object (e.g., object 226 in FIG. 2). The locations can be 16-bit IDs, for example.

The transmit element 104 can transmit a request to the plurality of nodes (e.g., plurality of nodes 222-1, 222-2, 222-3 in FIG. 2) to request range data. The transmit element 104 can also transmit the distance measurements to a command node (e.g., command node 223 in FIG. 2).

The transmit element 104 can include a transmitter and an antenna, for example, and the wireless transmissions can be transmitted via any number of methods, such as, but not limited to, LoRa modulated, LoRaWAN, WiFi, 15.4 mesh, Bluetooth, or Bluetooth mesh. For example, the wireless transmissions can be transmitted using a 2.4 GHz ISM band LoRa modulation, which is a combination of LoRa, Wi-Fi, 15.4, and Bluetooth mesh.

In various embodiments, the object tracker 100 can include a power source 108. As discussed above, the wireless transmissions can be received at particular intervals. The wireless transmissions can be received at particular intervals to conserve the power source 108. In some examples, the power source 108 can be from power harvesting, a battery, a fuel cell, or a supercapacitor.

FIG. 2 is a diagram of an example of a system for an object tracker that can be utilized according to an embodiment of the present disclosure. The system 220 can include an object 226, an object tracker 200, a plurality of nodes 222-1, 222-2, 222-3, and a command node 223.

Each of the plurality of nodes 222-1, 222-2, 222-3 can include a receive element 202-1, 202-2, 202-3, a transmit element 204-1, 204-2, 204-3, and a power source 208-1, 208-2, 208-3.

The plurality of nodes 222-1, 222-2, 222-3 can be scattered over an area. Once placed, each of the plurality of nodes 222-1, 222-2, 222-3 can communicate with each other to determine distances between each of the plurality of nodes 222-1, 222-2, and 222-3. The plurality of nodes 222-1, 222-2, 222-3 can also transmit the distances between each of them and/or their locations to the object tracker 200 for automatic infrastructure set up. The locations can be 16-bit IDs, for example. In some examples, if automatic infrastructure setup is unavailable, the locations of or the distances between the plurality of nodes 222-1, 222-2, 222-3 can be manually entered into the object tracker 200.

The plurality of nodes 222-1, 222-2, 222-3 can include three nodes placed over a square acre, for example. The distance between the plurality of nodes 222-1, 222-2, 222-3 can depend on the environment and the transmitted power. For example, the distance between the plurality of nodes 222-1, 222-2, 222-3 in a square acre of an open field can be greater than the distance between the plurality of nodes 222-1, 222-2, 222-3 in a square acre of a warehouse, a multipath environment. Barriers between a transmit element 204-1, 204-2, 204-3 and receive element 202-4 can weaken a transmission signal. As such, a transmit element 204-1, 204-2, 204-3 may use more power from a power source 208-1, 208-2, 208-3 to strengthen the transmission signal.

The plurality of nodes 222-1, 222-2, 222-3 can include a plurality of transmitter power levels. The amount of power in the one or more transmit elements 204-1, 204-2, 204-3 can dictate the distance that can be between the plurality of nodes 222-1, 222-2, 222-3. For example, the further the distance the transmissions must travel, the more power that a node of the plurality of nodes 222-1, 222-2, 222-3 needs to transmit. The closer the distance the transmission must travel, the less power that a node of the plurality of nodes 222-1, 222-2, 222-3 needs to transmit.

The plurality of nodes 222-1, 222-2, 222-3 can use an adaptive transmit power technique. The adaptive transmit power technique can allow the plurality of nodes 222-1, 222-2, 222-3 to save power by tuning the transmit power of the transmit element based on the distance the transmission must travel.

The object tracker 200 can be, but is not limited to, a radio, a mobile device, or a wearable device. The wearable device can be a smart watch, smart goggle, smart safety vest, smart safety shoes, smart headphone, or smart fall protection safety harness device, for example.

The object tracker 200 can collect and transmit data. As discussed above, the object tracker 200 can include a receive element 202-4, a transmit element 204-4, a position calculator 206, a power source 208-4, a processor 210-1, a memory 212-1, a ToF LoRa ranging engine 214, and an inertial navigation system 216.

The object tracker 200 can collect data via the receive element 202-4 and transmit data via the transmit element 204-4. As discussed above, the data can be range data of the object 226 from each of the plurality of nodes 222-1, 222-2, 222-3. For example, the range data can include a first range from a first node 222-1 to the object 226, a second range from a second node 222-2 to the object 226, and a third range from a third node 222-3 to the object 226. In various embodiments, the object tracker 200 transmits range data via LoRa in response to GPS being unavailable. In some examples, the range data can be transmitted by a 2.4 GHz ISM band LoRa modulated ToF modulation.

As discussed above, the object tracker 200 can receive the range data from the plurality of nodes 222-1, 222-2, and 222-2. In some examples, the range data can be ToF range data. The range data can be stored in the memory 212-1 of the object tracker 200. The memory 212-1, can be non-volatile memory, for example.

The object tracker 200 can convert the range data to a distance measurement of the distance of each of the plurality of nodes 222-1, 222-2, 222-3 to the object 226. The distance measurements can be in x-coordinates and y-coordinates. The object tracker 200 can then transmit the distance measurements to a device. The device can be a command node 223, for example. In some embodiments, the object tracker 200 can transmit the range data to allow another device to convert the range data.

The command node 223 can include a processor 210-2, a memory 212-2, a receive element 202-5, a power source 208-5, and a user interface 224.

The command node 223 can receive the distance measurements from the object tracker 200. The distance measurements can be displayed by the command node 223 to a user via a user interface 224. For example, the user interface 224 can include a display to convey the distance measurements to the user. The command node 223 can be, but is not limited to, a cloud server or a mobile device, such as a smart phone, tablet, or computer with an ethernet connection.

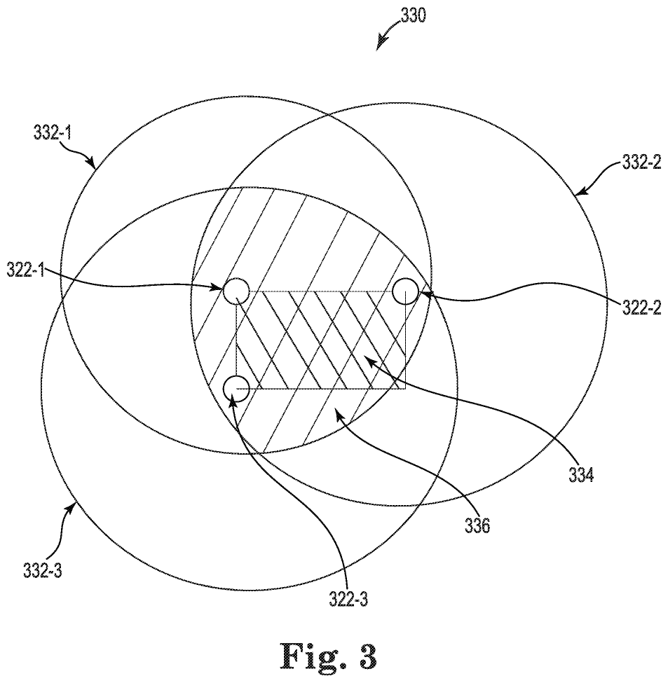

FIG. 3 is a diagram illustrating trilateration according to an embodiment of the present disclosure. The trilateration diagram 330 includes a plurality of nodes 322-1, 322-2, 322-3 with a plurality of transmission areas 332-1, 332-2, 332-3, which overlap to create a tracking zone 336. The trilateration diagram 330 also includes a Cartesian box 334 to plot the distance measurements.

The trilateration diagram 330 illustrates how the object tracker (e.g., object tracker 200 in FIG. 2) locates an object (e.g., object 226 in FIG. 2) using a plurality of nodes (e.g., plurality of nodes 222-1, 222-2, 222-3 in FIG. 2).

The trilateration diagram 330 includes a plurality of nodes 322-1, 322-2, 322-3. Each of the plurality of nodes 322-1, 322-2, 322-2 have a transmission area 332-1, 332-2, 332-3. The transmission area 332-1, 332-2, 332-3 is an area where a node of the plurality of nodes 322-1, 322-2, 322-3 can receive and transmit a signal to the object tracker (e.g., object tracker 200 in FIG. 2).

Where a number of the transmission areas 332-1, 332-2, 332-3 overlap can be a tracking zone 336. The object (e.g., object 226 in FIG. 2) can be tracked anywhere within the tracking zone 336.

The distance measurements converted from the range data can be in a Cartesian coordinate system in absolute x-coordinates and y-coordinates, with units of feet, miles, yards, meters, or kilometers, for example. In some embodiments, the distance measurements can be plotted on the trilateration diagram 330 using the Cartesian box 334 to locate an object (e.g., object 226 in FIG. 2).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. An object tracker, comprising:
a receive element to receive wireless transmissions from a plurality of nodes including range data of an object from each of the plurality of nodes, wherein each of the plurality of nodes tune a power of the wireless transmissions based on a distance from each of the plurality of nodes to the receive element;
a position calculator to convert the range data to distance measurements of the distance of each of the plurality of nodes to the object; and
a transmit element to transmit the distance measurements to a command node.

2. The object tracker of claim 1, wherein the wireless transmissions are via at least one of: long range (LoRa) modulated, LoRaWAN, WiFi, 15.4 mesh, Bluetooth, or Bluetooth mesh.

3. The object tracker of claim 1, further including a power source.

4. The object tracker of claim 3, wherein the object tracker receives wireless transmissions at a particular interval to conserve the power source.

5. The object tracker of claim 1, wherein the position calculator uses a trilateration algorithm.

6. The object tracker of claim 1, wherein the object tracker receives wireless transmissions in response to the object tracker moving or the object tracker being still for a particular period of time.

7. The object tracker of claim 1, wherein the transmit element transmits a request to the plurality of nodes to request the range data.

8. The object tracker of claim 1, wherein the distance measurements are in at least one of: meters, kilometers, yards, feet, or miles.

9. The object tracker of claim 1, wherein the distance measurements are transmitted to the command node via at least one of: long range (LoRa) modulated, LoRaWan, WiFi, 15.4 mesh, Bluetooth, or Bluetooth mesh.

10. A system for an object tracker, comprising:
a plurality of nodes to collect and transmit range data of an object from each of the plurality of nodes, wherein each of the plurality of nodes tune a transmit power based on a distance from each of the plurality of nodes to an object tracker;
the object tracker to receive the range data from the plurality of nodes, convert the range data to x-coordinates and y-coordinates, and transmit the x-coordinates and y-coordinates; and
a command node to receive and display the x-coordinates and y-coordinates.

11. The system of claim 10, wherein the plurality of nodes include at least three nodes.

12. The system of claim 10, wherein the plurality of nodes transmit range data via long range (LoRa) modulation in response to a global positioning system (GPS) being unavailable.

13. The system of claim 10, wherein the command node is a cloud server, a mobile device, or an ethernet enabled computer.

14. The system of claim 10, wherein absolute time of flight (ToF) range data of the plurality of nodes are transmitted to the object tracker.

15. The system of claim 10, wherein the plurality of nodes include a plurality of power sources.

16. The system of claim 10, wherein a tracking zone includes an overlap of a plurality of transmission areas of the plurality of nodes.

17. (canceled)

18. A system for an object tracker, comprising:
a plurality of nodes, wherein each of the plurality of nodes tune a transmit power based on a distance from each of the plurality of nodes to a wearable device;
the wearable device to collect range data, convert the range data to x-coordinates and y-coordinates, and transmit the x-coordinates and y-coordinates, wherein the range data includes:
a first range from a first node of the plurality of nodes to the wearable device;
a second range from a second node of the plurality of nodes to the wearable device; and
a third range from a third node of the plurality of nodes to the wearable device; and
a command node to receive and display the x-coordinates and y-coordinates.

19. The system of claim 18, wherein the range data is time of flight (ToF) range data.

20. The system of claim 18, wherein the wearable device is a smart watch, smart goggle, smart safety shoes, smart safety vest, smart headphone, or smart fall protection safety harness device.
